(19) United States
(12) Patent Application Publication
(10) Pub. No.: US 2008/0044340 A1
(43) Pub. Date: Feb. 21, 2008

(54) Method for Producing Highly Monodisperse Quantum Dots

(75) Inventors: Dengguo Wu, Athens, OH (US); P. Gregory Van Patten, Athens, OH (US)

Correspondence Address: CALFEE HALTER & GRISWOLD, LLP, 800 SUPERIOR AVENUE, SUITE 1400, CLEVELAND, OH, 44114, US

(73) Assignee: OHIO UNIVERSITY, Athens, OH (US)

(21) Appl. No.: 11/628,966

(22) PCT Filed: Jun. 10, 2005
(86) PCT No.: PCT/US05/20725

§ 371 Date: Aug. 20, 2007

Related U.S. Application Data
(60) Provisional application No. 60/578,599, filed on Jun. 10, 2004.

(51) Int. Cl. B82B 3/00; C01B 17/20; C01B 19/04; C01G 11/02; C01G 13/00; C01G 21/21; C01G 3/12; C01G 9/08

(52) U.S. Cl. 423/509; 423/508; 423/565; 423/592.1; 423/594.18; 423/604; 423/620; 423/622; 977/774

(57) ABSTRACT

A method for producing highly monodisperse nanocrystals comprising the steps of: a) preparing a precursor comprising a metal ion and a coordinating ligand; b) dissolving the precursor in a solvent mixture comprising coordinating solvent and optionally non-coordinating solvent; c) raising the temperature of the step b mixture into the range from 150° C. to 350° C.; d) adding a chalcogen to the step c heated mixture whereby the chalcogen reacts with the precursor; e) lowering the temperature of the step d mixture to stop the reaction; and e) maintaining the step e cooled mixture for sufficient time at sufficient temperature to narrow the size distribution of the nanocrystals. The methods greatly reduce or eliminate the need for trioctylphosphine oxide (TOPO); provide control over particle size, and permits facile production of high quality nanocrystals with very small diameters (<4 nm). CdSe nanocrystals produced via the methods are shown in the Figure.

### CROSS-REFERENCE TO RELATED APPLICATIONS

This application claims priority to U.S. Provisional Patent Application No. 60/578,599, filed Jun. 10, 2004, the entirety of which is incorporated herein by reference.

### BACKGROUND OF THE INVENTION

First discovered in 1990, quantum dots already represent a promising industry, with current sales in the multimillion dollars, and the promise of much growth ahead. Because the electronic and optical properties of these materials can be tuned, quantum dots offer tremendous potential for many new applications. New applications are emerging, such as biomedical and electro-optical applications, offering the potential for tremendous growth. The properties of these nanocrystals (also known as “quantum dots”) are dependent upon their size and the chemical species present on their surfaces.

For optimum performance, these nanocrystals must a) have a narrow range of sizes, b) be encased in a thin shell of another appropriate material such as ZnS, and c) be capped by a molecular layer that prevents agglomeration and promotes solubility.

In 1993, M. G. Bawendi and coworkers described a method for producing such nanocrystals. Their methods have been modified and adapted over the past decade but are still commonly used more or less in their original form. The method uses organometallic reagents (such as dimethylcadmium) in strongly coordinating solvents such as trioctylphosphine (TOP), trioctylphosphine oxide (TOPO), and/or phosphonic acids such as hexadecylphosphonic acid.

The organometallic precursors are air- and water-sensitive and present an explosion hazard under the conditions of the reaction. The method allows for the production of nanocrystals with a moderately narrow size distribution (+/−10% diameter). Bawendi and coworkers also developed a method for narrowing the size range further (to +/−5% diameter) through a method called size-selective precipitation SSP. The SSP method results in the creation of numerous samples of different size ranges from a single reaction. The resulting size distribution after SSP is the best currently possible and would be considered “state-of-the-art.”

Unfortunately, the Bawendi method has several drawbacks, including: 1) the procedure is hazardous; 2) the reagents are extremely air- and water-sensitive and require difficult air-free manipulations and expensive equipment for these manipulations; 3) the yield of the nanocrystals within a given narrow size range is quite low since each preparation (after SSP) actually produces nanocrystals of various sizes; 4) the organometallic reagents and coordinating solvents TOP and TOPO are quite expensive; and 5) the coordinating solvents TOP and TOPO are toxic to the environment. The low reaction yield and large quantity of the phosphorous-containing compounds couple to produce an environmentally unfriendly process.

These drawbacks all present problems for manufacturers of CdSe nanocrystals. All of the drawbacks listed lead to significant increases in cost of production for these nanocrystals.

More recently, Peng and coworkers have eliminated organometallic Cd precursors from the method and have replaced these with CdO, CdCO₃ and other Cd salts. Peng included a fatty acid as a coordinating factor in his reaction mixture. Unfortunately, the fatty acids used by Peng allow the reaction and particle growth to occur very rapidly (within a few seconds). Using this method, the reaction cannot be stopped quickly enough to produce high-quality dots of very small size (<3.5 nm). Moreover, the size control offered by Peng's method is not as precise as that offered by Bawendi's method. However, SSP can be used to achieve a narrow size distribution. While Peng's method solves some of the issues with the Bawendi method, the size distribution in Peng's product is worsened relative to the Bawendi method, meaning the reaction yield (computed after SSP) is also worsened. In addition, some size ranges are completely inaccessible by Peng's method.

A method is desired which will provide quantum dots with a narrow size distribution as well as with great control over the size. The method should allow the production of high quality nanocrystals with very small sizes. Additionally, it would be desirable to have a method that reduces or eliminates the need for TOPO. It would also be desirable that the method provide quantum yields of 50% or greater.

### SUMMARY OF THE INVENTION

Provided herein are new methods for the preparation of CdSe and other nanoparticular quantum dots. The inventive methods provide ultrafine control over particle size than known methods. Using the methods described herein, narrow size ranges are achieved, without the necessity of using size selection precipitation. The methods described herein use much less solvent that conventional methods and reduce or eliminate the need to use TOPO, which has been universally used in the production of quantum dots to date, leading to a less expensive as well as greener method for the preparation of quantum dots.

Provided herein is a method for the production of monodisperse nanocrystals, the method comprising the steps of

a) preparing a precursor comprising a metal ion and a coordinating ligand;

b) dissolving the precursor in a coordinating solvent, a mixture of coordinating solvents, or a mixture of coordinating solvent and non-coordinating solvent;

c) adjusting the temperature of the precursor and solvent mixture to between 150° C. and 350° C.;

d) reacting a chalcogen with the precursor for a length of time to form nanocrystals of the desired size; and

e) ending the reaction by lowering the temperature of the mixture.

The reaction is maintained at the lowered temperature for a time sufficient to narrow the particle size distribution, whereby particle size distributions of +/−10%, +/−7%, and even +/−5% diameter may be obtained without the necessity for further treatment, such as size-selective precipitation.

In accordance with the methods described herein, the metal is selected from the group consisting of Cd, Zn, Cu²⁺, Pb²⁺, Hg, and combinations thereof; in many embodiments, the metal is Cd; the coordinating ligand is selected from the group of carboxylic acids; amines; sulfonates; sulfoxides; phosphonates; di-carboxylic acids; diamines; ketones, aldehydes, esters; and combinations thereof; in some embodiments, the coordinating ligand is a carboxylic acid, in some embodiments, the coordinating ligand is stearic acid; the coordinating solvent is selected from the group consisting of amines, carboxylic acids, sulfonates, sulfoxides, phosphonates, di-carboxylic acids, diamines, ketones, aldehydes, esters, and combinations thereof; mixtures of amines, carboxylic acids, sulfonates, sulfoxides, phosphonates, di-carboxylic acids, diamines, ketones, aldehydes, esters, and combinations thereof and TOPO. The non-coordinating solvent is selected from straight-chain, branched, and cyclic alkanes and alkenes which are desirably, though not necessarily liquid at room temperature and desirably, though not necessarily have a boiling point of 150° C. or higher; preferred non-coordinating solvents include octadecene and octadecane; and the chalcogen is selected from the group consisting of Se, S, Te, and combinations thereof.

In accordance with the methods described herein, the longer the reaction time used, generally, the larger the resulting nanocrystals will be. However, as explained herein, changing other factors, will also affect the final size of the nanoparticles.

The reaction is ended by lowering the temperature of the reaction mixture. In some embodiments, the temperature is lowered and the nanocrystals are held at that temperature for a time sufficient to narrow the particle size distribution to a desired level. Using the methods described herein, particle size distributions of +/−10%, +/−7%, and even +/−5% diameter may be obtained without further treatment, such as size-selective precipitation. In one embodiment, the nanocrystals are maintained at about 150° C. for about three hours to achieve the desired polydispersivity. The temperature at which the crystals are maintained and the length of time for which the nanocrystals are maintained at that temperature may readily be determined by those skilled in the art.

In accordance with the methods described herein, the ratio of anion to metal may be adjusted to form nanocrystals of particular sizes. Under the conditions we typically employ, we find that nanocrystals no larger than about 4 nm diameter can be obtained using Se:Cd=10:1; nanocrystals no larger than about 5 nm diameter can be obtained using Se:Cd=5:1; about 6 nm nanocrystals can be obtained using a ration of Se:Cd=2.1; and further changes in the ratio allow for the production of larger particles still. Lastly, the reaction temperature can be used to control nanocrystal size. Again, under conditions typical for our laboratory, and maintaining all other conditions constant, we have observed that CdSe nanocrystals less than 2 nm can be obtained at 200° C., a size of approximately 6 nm can be obtained at 350° C.

The methods described herein also allows for the addition of a protective shell and for transfer of these nanocrystals to other solvents, including water, by established methods, if desired. Quantum yields in excess of 50%, and up to 80% have been achieved.

### BRIEF DESCRIPTION OF THE DRAWINGS

FIG. 1 shows (a) UV visible absorption spectra and (b) PL spectra of four CdSe NC samples prepared under similar reaction conditions but with different capping ligands employed in place of TOPO. From top to bottom, the samples were prepared with TOPO, without TOPO or any substitute reagent, with 1 g benzophenone in place of TOPO, and with 0.1 g hexadecyl hexadecanoate in place of TOPO.

FIG. 2 shows UV-visible absorption and PL emission spectra of different sized CdSe NCs prepared by the method described herein. Complete size statistics for these NCs are given in Table 2.

FIG. 3 shows TEM images of CdSe NCs prepared in the presence of HH. Average particle diameters in these samples are (a) 4.7 nm and (b) 5.7 nm. Images at right are higher magnification images taken from the same samples as those shown at left.

### DETAILED DESCRIPTION OF THE INVENTION

A new method is described for the synthesis of high quality nanocrystals (NCs), such as but not limited to CdSe nanocrystals, that eliminates the need for tri-octylphosphine oxide (TOPO). High-boiling esters and ketones such as hexadecyl hexadecanoate (HH) and benzophenone (BP) are shown to be excellent replacements for TOPO in this reaction. Compared with TOPO, HH offers a significant synthetic advantage as it slows the initial growth of the NC nuclei formed after injection of the Se precursor. This allows for superior control over particle size in the initial stages of the reaction, and thus permits facile production of high quality NCs with very small diameters (<4 nm).

This new synthetic method allows for the preparation of CdSe quantum dots with very high size uniformity without post-synthetic size selections processes. Prior to this method, the very best polydispersity (size distribution) that could be achieved without size selective precipitation was approximately ±15% and at very best ±10%. Using the methods described herein, it is possible to achieve a polydispersity of at least ±10% diameter. In some embodiments, it is possible to achieve a polydispersivity of ±7% to ±10%. In still other embodiments, it is possible to achieve a polydispersivity of ±5% without resorting to the size selection procedures. The result is a process that exhibits a much higher overall product yield, a significantly lower environmental impact, and a much lower overall cost than has previously been possible. In addition, the reagents used in the preferred embodiment of the present method are less air- and water-sensitive and less prone to explosion than the reagents typically used for preparing CdSe quantum dots. This further simplifies and reduces the cost of synthesis. Moreover, the methods described herein provide high yields, with narrow particle-size distributions using air-stable reagents. Additionally, the inventive methods also eliminate P-containing pollutants.

Quantum dots have already found use in many areas, particularly in biological applications, such as biological imaging, and electo-optical applications, such as lasers. Additional uses that have been identified include, but are not limited to detecting molecules, such as biotoxins, which may be used in terrorism; single molecule imaging and cellular imaging applications; in biological reagents; as components in inks to use as barely-visible bar codes; use in light-emitting devices (LEDs) and lasers; use in telecommunication devises such as operational amplifiers and waveguides; and applications in quantum computing to name a few.

The quantum dots prepared by the methods described herein are suitable for use in any known application for which quantum dots have been used or which may be developed. Because of the monodispersivity of the dots produced by the inventive methods, the methods are particularly well-suited for applications where a large amount of mono-disperse quantum dots are needed, as the methods can be used to prepare large quantities of monodisperse quantum dots. Conventional methods, on the other hand, yield a range of particle sizes in any batch, which must be separated by size selection precipitation, making it costly and difficult to prepare large quantities of monodisperse quantum dots.

The methods described herein have changed the solvent and precursors involved. The method described herein does not require organometallic reagents, significantly reduces the reliance on TOP and TOPO, and allows for the production of extremely narrow particle size distributions without any size selection procedures. In some embodiments, the amount of TOPO is greatly reduced, while in other embodiments, the use of TOPO is eliminated. The non-reliance on TOPO results in greatly reduced costs, because TOPO is both expensive to purchase and to dispose. The non-reliance of TOPO is also environmentally important, because TOPO is known to be dangerous to the environment, especially marine life.

Using this method, we have identified no less than four experimental parameters that allow us to tune particle size. These are: 1) reaction time, 2) reaction temperature, 3) volume of non-coordinating solvent, and 4) Cd:Se (or similar) ratio.

A new part of this method is the use of an air-stable coordination complex of the metal, the “precursor,” that is soluble in organic solvents. A preferred coordination complex for this purpose has been cadmium stearate. The carboxylic acid of the stearate ligand is bound sufficiently strongly to the Cd to retard the reaction relative to Peng's Cd salts. The stearate may also some fraction of the molecular coating on the surfaces of the nanocrystals; this inclusion of a capping ligand directly in the precursor allows for a relative reduction in the concentration of coordinating solvent since each CD ion is already doubly coordinated. Consequently, as described below, TOP and TOPO can be almost completely eliminated or completely eliminated from the reaction mixture. The primary solvents are a more weakly-coordinating solvent such as hexadecylamine (HDA) and a non-coordinating solvent such as octadecane. The entire process takes between a few minutes and several hours, depending on the desired particle size.

Using this procedure, there are four ways to control particle size. Firstly, an increase in reaction time generally results in the production of larger nanocrystals. Secondly, an increase in the proportion of non-coordinating solvent (such as octadecane) will produce a concomitant increase in particle size. Thirdly, the molar ratio of Se:Cd can be used to control size. Under the conditions we typically employ, we find that nanocrystals no larger than about 4 nm diameter can be obtained using Se:Cd=10:1; nanocrystals no larger than about 5 nm diameter can be obtained using Se:Cd=5:1; about 6 nm nanocrystals can be obtained using a ration of Se:Cd=2.1; and further changes in the ratio allow for the production of larger particles still. Lastly, the reaction temperature can be used to control nanocrystal size. Again, under conditions typical for our laboratory, and maintaining all other conditions constant, we have observed that CdSe nanocrystals less than 2 nm can be obtained at 200° C., a size of approximately 6 nm can be obtained at 350° C., and a size larger than 6 nm can be obtained at 350° C.

In most embodiments, once the reaction is complete, the reaction mixture is held for a time sufficient to narrow the particle size distribution to a desired level. During this time, the size distribution narrows greatly due to Ostwald ripening, a phenomenon known to those skilled in the art. In some embodiments, the temperature is lowered and the nanocrystals are held at that temperature for a time sufficient to narrow the particle size distribution to a desired level through Ostwald ripening. Using the methods described herein, particle size distributions of +/−10%, +/−7%, and even +/−5% diameter may be obtained without the necessity for further treatment, such as size-selective precipitation. In one embodiment, the nanocrystals are maintained at about 150° C. for about three hours to achieve the desired polydispersivity. The temperature at which the crystals are maintained and the length of time for which the nanocrystals are maintained at that temperature may readily be determined by those skilled in the art.

There are a couple of unexpected results. The first is that the nanocrystal size control can be very precise if a coordinating ligand is built directly into the Cd precursor (stearate is one example). The resulting size control is so good that even if size selective precipitation were used, it would be unlikely to result in a narrower size range. To our knowledge, this has never before been achieved. Room temperature photoluminescence emission spectra of as-prepared nanocrystals showed peak widths (FWHM) of 20-25 nm (data not shown), consistent with a very narrow size range. Using prior state-of-the-art methods would typically require multiple precipitations from the reaction mixture to achieve the size distribution using the methods described herein.

The second surprising result is that a simple Cd salt such as cadmium stearate can be used to synthesize these nanocrystals with such precise size control. In light of Peng's results, it is especially surprising that even very small (<4 nm) nanocrystals can be produced in this way with a narrow size distribution.

The present method allows for the addition of the protective shell and for transfer of these nanocrystals to other solvents (such as water) by established methods, if desired. Quantum yields in excess of 50% in some embodiments, greater than 60% in some embodiments, greater than 70% in still other embodiments, and even greater than 80% in some embodiments have been measured in these samples.

Several parameters of the methods described herein may be changed to produce quantum dots with other properties. In place of cadmium, other metals such as zinc, mercury, copper(II), and lead(II) may be used. These may be substituted for Cd using the same molar ratios as for Cd. The selenium may be replaced with sulfur or tellurium, again using the same molar ratios. The substitutions being straightforward and readily done by those skilled in the art.

Any of several non-coordinating solvents may be used. The non-coordinating solvent are is chosen such that first, it has a boiling point that is high enough to be heated to the temperatures used in accordance with the methods described herein, about 150° C. to about 350° C.; and second, it is compatible with the capping group. It is also desirable, but not required, that the non-coordinating solvent is liquid at room temperature. Hydrocarbons, including straight-chain, branched and cyclic alkanes and alkenes, and mixtures or combinations thereof, for example, are suitable provided that they have the characteristics described above. Other non-coordinating solvents may be recognized by those skilled in the art. In one embodiment, the solvent is octadecene (ODE), in another embodiment, the solvent is octadecane. In still another embodiment, the solvent is ODE and octadecane. In other embodiments, other suitable solvents are used.

Coordinating solvents are chosen such that they bind rather strongly to the surface of the quantum dot particles and such that their boiling points are high enough to allow heating to the desired temperatures, generally in the range from about 150° C. to about 350° C. Coordinating solvents may be selected from such things as amines, high-boiling esters, ketones, and combinations thereof. In some embodiments of the methods described herein, a mixture of TOPO and another coordinating solvent is used. In other embodiments, the TOPO is eliminated completely. In some embodiments, the coordinating solvents include amines, such as 1-hexadecylamine (HAD) and trictylamine. In other embodiments, the coordinating solvent is a high-boiling ester, such as hexadecyl hexadecanoate (HH). In other embodiments, the coordinating solvent is a ketone, such as benzophenone (BP). In still other embodiments, the coordinating solvent is a combination or mixture of two or more individual coordinating solvents. Other coordinating solvents could readily be identified by those skilled in the art.

The coordinating solvent may be a single solvent or a mixture of solvents. In one embodiment, a minimum of about 2% TOPO (2% of the total solvent mass) is used. In some embodiments, another coordinating solvent such as stearic acid, acetic acid, hexadecylamine, or some combination thereof is present in addition to the TOPO. In yet another embodiment, 100% TOPO may be used as the coordinating solvent. In some embodiments, a non-coordinating solvent is added to the mixture as well. The percentage of the non-coordinating solvent may range from 0% up to probably 90% or even more.

The capping group or coordinating ligand is chosen to have two basic properties. First, it attaches firmly to the metal ion, and second, it helps keep the finished nanoparticles in solution. Stearate is a preferred capping group, as the acid group is able to firmly attach to the metal ion, and the hydrocarbon portion effectively keeps the prepared quantum dots in solution. The acid group may be replaced with other groups, including but not limited to amines; sulfonates; sulfoxides; phosphonates; di-carboxylic acids; diamines; derivatives of carboxylic acids such as ketones, aldehydes, esters; other Lewis base ligands, and so forth. The hydrocarbon chain may be saturated or unsaturated and can be of varying lengths.

The nanocrystals prepared using the methods described herein may undergo further treatment to enhance their performance for specific uses. Any conventional treatments may be used, as well as treatments that are still being developed. For example, the nanocrystals may be encased in a thin shell of an appropriate material, such as ZnS; the nanocrystals may also be capped by molecular layer that prevents agglomeration and promotes solubility. Such treatments are known to those of ordinary skill in the art.

The methods described herein eliminate the need for size selection precipitation, though the inventive methods could be coupled with size selection precipitation to achieve even greater monodispersivity.

Specific Details of Synthetic Procedure

The precursor of cadmium stearate is synthesized and dried by established methods. A variety of coordinating ligands other than stearate may be used in this precursor. In particular, other ligands containing a carboxylate functionality which can coordinate to the Cd ion are may be used. Additionally, certain other Lewis base ligands may be used. Among these phosphonates, sulfoxides, derivatives of carboxylic acids (such as ketones, aldehydes or esters), and thiols.

The Cd-containing precursor is dissolved in a mixture of coordinating and non-coordinating solvents. In some embodiments, the coordinating solvents may include TOPO and HDA. In other embodiments, no TOPO is used. In accordance with the methods described herein, any number of other known coordinating solvents may be used. Amines such as HDA and trictylamine seem to be particularly good substitutes for TOPO and allow for minimization of the use of this undesirable ingredient. Examples of other coordinating solvents include, but are not limited to amines; carboxylic acids; sulfonates; sulfoxides; phosphonates; di-carboxylic acids; diamines; ketones, aldehydes, esters; and combinations thereof. The primary considerations for these coordinating solvents is that they should bind rather strongly to the surface of the CdSe particles and that their boiling points should be high enough to allowing heating to the desired temperature (typically between 150° C. and 350° C.). The non-coordinating solvents are generally a long chain alkane or alkene such as octadecene (ODE). However, many other solvents might be used, provided that they do not bind to the nanocrystal surface and that their boiling point is high enough to allow heating to the desired reaction temperature. The resulting solution is heated to the desired reaction temperature under a stream of Ar gas. In another flask, trioctylphosphine selenide (TOPSe) is prepared by established methods and this reagent is injected (hot) into the solution containing the Cd precursor. Reaction is ceased by lowering the temperature to 150° C. for three hours.

### EXAMPLE 1

Chemicals Trioctylphosphine oxide (TOPO), trioctylphosphine (TOP), hexadecylamine (HDA), octadecene (ODE), stearic acid, and Se powder were purchased from Aldrich Cd(ClO₄)₂—H₂O, methanol, chloroform, and acetone were purchased from Fisher Scientific, Inc.

Cadmium stearate preparation. Stearic acid (1 mmol) was reacted with 1 mmol NaOH in hot deionized water. After the stearic acid is completely dissolved in this water solution, 1.1 mmol Cd(ClO₄)₂ was added to the solution with vigorous stirring. Cadmium stearate quickly precipitated from this solution. After cooling to room temperature, cadmium stearate was vacuum filtered and dried.

Nanocrystals synthesis Cadmium stearate (0.1 mmol), TOPO (0.25 g), HDA (1 g), and ODE (10 mL) were dried and degassed in a reaction flask by heating to 150° C. for 30 minutes under a stream of argon. The temperature was then raised slowly to 320° C. under 1 atm Ar, and 1 mmol Se powder which had been dissolved in hot TOP was injected rapidly by syringe into the rapidly stirring solution. After about 10 minutes, the solution had an intense red color. At this time, the reaction was stopped by removing the heater. The reaction was kept at 150° C. for about three hours following this. Nanocrystals with a very narrow size distribution (+/−5% diameter) were obtained by this method.

Changing one of the four experimental parameters mentioned above allows one to precisely and predictably vary the size of the particles. The color of the particles gives a qualitative indication of the size. As the particles grow, the reaction mixture goes through a series of colors: colorless, light yellow, deep yellow, orange, red, brown-red, brown, black.

### EXAMPLE 2

All chemicals were used as received without further purification. Selenium powder (99.999%), octadecane (ODA) 99%, technical grade tri-octylphosphine oxide (TOPO) 90%, technical grade 1-hexadecylamine (HDA) 90%, benzophenone (BP) 99%, hexadecyl hexadecanoate (HH) 98%, trioctylphosphine (TOP), and stearic acid 98+% were obtained from Aldrich. Cadmium perchlorate was obtained from Alfa Aesar. Chloroform (reagent. A.C.S) was obtained from Spectrum Chemical Mfg. Corp. Methanol (HPLC) was obtained Fisher Scientific. Cadmium stearate was prepared by combining Cd(ClO₄)₂.6H₂O with stearic acid in hot de-ionized water (18.5 MΩ).

A typical synthesis is as follows: Cadmium stearate (0.1 mmol), HH (0.1 g), HDA (1 g) and ODA (5 g) were dried and degassed in a reaction flask by heating to 200° C. for 30 min under a stream of argon. The temperature was then raised quickly to 320° C. under 1 atm Ar, and 1 mmol Se dissolved in a few milliliters TOP was injected quickly by syringe into the rapidly stirring solution. Color changes were observed over a period of minutes following injection, progressing from colorless to yellow to orange to red to dark red. Some time after injection of the Se, and judging from the solution color or absorption measurements, the heat source was removed to stop the reaction. The temperature was stabilized and maintained at 150° C. for three hours during which some size focusing is observed to occur. Nanocrystals with a very narrow size distribution were obtained. By adjusting growth time, reaction temperature, Cd:Se molar ratio, and the amount of non-coordinating solvent, the mean particle size could be tuned over a broad range. In general, larger particles were favored by increasing growth times, by elevating the reaction temperature, by raising the Cd:Se molar ratio, and by reducing the amount of non-coordinating solvent.

The importance of TOPO was tested by performing the same reaction while omitting TOPO. In addition, other potential capping ligands were substituted for TOPO in numerous trials. Of particular interest were the cases in which 1 g BP or 0.1 g HH were substituted for the 0.25 g of TOPO.

After the reaction mixture had cooled to about 60° C., excess methanol was added. CdSe NCs were extracted into the ODA phase while excess coordinating solvent and unreacted precursors were removed with the methanol phase. This extraction was repeated 4 times. It was found that the addition of a few milliliters of chloroform improved the separation. Following the methanol extraction, excess acetone was added to precipitate the NCs from the ODA phase. The sample was centrifuged to ensure high collection yield. The resulting powder was dissolved in chloroform for future use.

Size selective precipitation was not necessary to further narrow the size distribution. UV-visible absorption measurements were carried out using an Agilent Technologies 8453 diode array spectrophotometer. Photoluminescence (PL) emission measurements were performed using a Photon Technology International C-60 spectrophotometer. A 75 W Xe lamp and monochromator were used to select 500 nm light for excitation. Emitted light was collected at 90° from the excitation and focused into a double monochromator with a photomultiplier tube detector operating in photon counting mode.

For transmission electron microscopy (TEM) measurements, a few microliters of a highly diluted sample were placed onto copper grids coated with an amorphous carbon film and allowed to dry. A JEOL JEM-1010 Electron Microscope was used for imaging. Particle diameters were measured directly on photographic negatives at 120,000× magnification using a 30× magnifying loupe with reticle calibrated to 0.0025″.

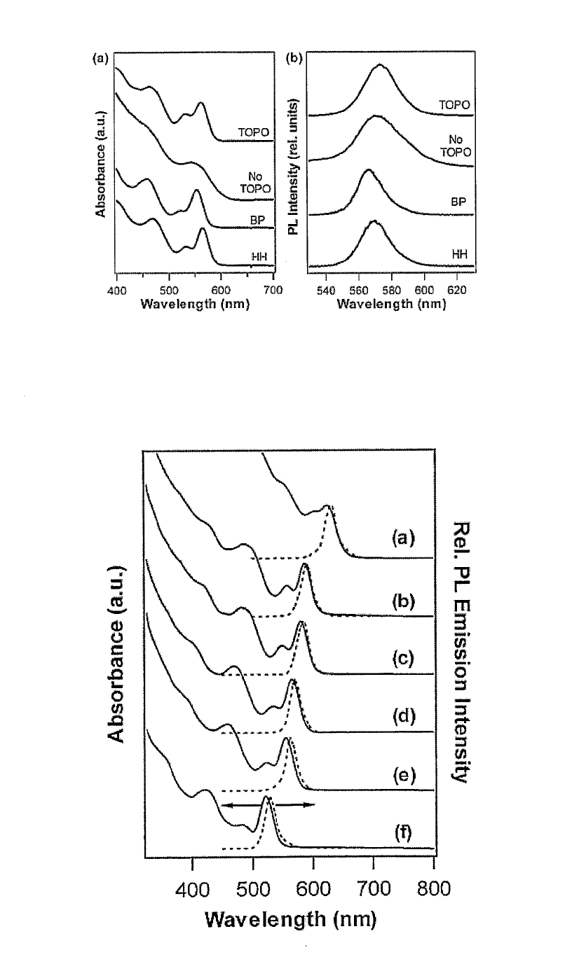

FIG. 1(a) shows UV-visible absorption spectra from four CdSe NC samples prepared under similar reaction conditions. The only difference between these four samples was the presence of TOPO or a substitute reagent for TOPO in the reaction mixture. The topmost spectrum is from a sample prepared with 0.25 g TOPO added into the reaction mixture. Below this are the spectra obtained (in order from top to bottom) without TOPO or any substitute ligand added into the reaction mixture, with 1.0 g BP substituted for TOPO, and with 0.1 g HH substituted for TOPO. The width of the first exciton absorption features, near 560 nm, are radically different in these four samples, indicating marked differences in the size heterogeneities of these samples.

A more quantitative comparison of size heterogeneity can be obtained from the PL emission spectra, which are shown in FIG. 1(b). Since the emission from a single nanocrystal is spectrally narrow, and since emission wavelength depends upon particle size, the emission peak width provides a convenient comparative measure of particle size distribution between various samples. In order to make this comparison, the emission spectra were fit to Gaussian spectral profiles, and the intensity observed within a particular wavelength range dλ was assumed to be directly proportional to the number of emitting nanocrystals within the corresponding size range σ_{D}. This analysis implicitly assumes that nanocrystals of all sizes within the sample are excited with equal probability and that the excited nanocrystals emit with equal probability. It is known that these assumptions lead to a systematic exaggeration of the size heterogeneity of the sample. For this reason, the size distributions of selected samples were also measured directly from transmission electron micrographs (see Tables 1 and 2). Trends in the direct TEM measurements closely followed the trends observed in the emission peaks widths. Emission peak width is emphasized as a relative measure of size homogeneity because this measurement is entirely unaffected by human biases which might affect the process of selection and measurement of particles from a TEM image field.

TABLE 1
Spectral characteristics and size statistics of DcSe NCs prepared in the presence of various
coordinating ligands

| | Peak Absorption | Peak Emission | Prevalent | | | |
|---|---|---|---|---|---|---|
| Coordinating | Wavelength | Wavelength | Diameter | Emission | σ_{D} (%) | σ_{D} (%) |
| Ligand | λₐ (nm) | λₑ (nm) | D (Å) | FWHM (nm) | (PL spectrum)^{a} | (TEM)^{b} |
| None | 541 | 570 | 29 | 33 | 16 | n/a |
| TOPO | 563 | 573 | 33 | 23 | 11 | 6.2 |
| BP | 554 | 566 | 21 | 18 | 8.3 | 5.5 |
| HH | 565 | 570 | 34 | 20 | 9.3 | 5.6 |

^{a}Relative standard deviation as estimated by a Gaussian fit to the emission spectrum. This method exaggerates the absolute σ_{D} value, but is useful for comparison of samples.
^{b}Relative standard deviation as estimated from measurements on transmission electron micrographs (N = 100 particles).

The mathematical relationship between emission wavelength and particle diameter was determined from measurements on a series of nearly monodisperse CdSe nanocrystal samples, each with a different mean particle size. In these calibration samples the prevalent particle size (i.e. most probable diameter, D) in a sample was determined from the absorption spectrum using the empirical equation previously reported by Yu et al. that relates D to λₐ, the wavelength in nanometers of the lowest energy excitonic peak in the absorption spectrum:
D=(1.6122×10⁻⁹)λₐ⁴−(2.6575×10⁻⁶)λₐ³+(1.6242×10⁻³)λₐ²−(0.4277)λₐ+41.57. (1)
The peak emission wavelengths, λₑ, of these same samples were then used to find the relationship between emission wavelength and particle diameter over the range of interest (2 nm-8.5 nm). The relationship between particle diameter and emission wavelength was found to obey the relationship:

$$D = ( 2.6786 ⨯ {10}^{- 9} ) {λ}_{e}^{4} - ( 4.9348 ⨯ {10}^{- 6} ) {λ}_{e}^{3} + \\ ( 3.4222 ⨯ {10}^{- 3} ) {λ}_{e}^{2} - ( 1.0511 ) {λ}_{e} + 121.74 . \qquad ( 2 )$$

For each sample, the abscissa of the PL spectrum was transformed from λₑ to D using equation (2) and a Gaussian function was fit to this size distribution function in order to determine the estimated standard deviation in the diameter, σD. Size statistics determined by this method are presented in Table 1 for the samples depicted in FIG. 1. As mentioned above, the relative standard deviation of the size distribution is measurably overestimated by the emission peak width, but this effect is systematic and does not hinder comparisons between samples.

The data in FIG. 1 show that HH (a long chain ester) and BP strongly favor narrow size distributions in CdSe nanocrystals. The size distribution for the sample prepared in the presence of BP and HH were even narrower than that obtained in the presence of TOPO. Although both of these alternative capping ligands performed well compared to TOPO, HH produced more reproducible size distributions than did BP (more consistent in both mean diameter and standard deviation) and required less material for equivalent performance. Based on these observations, further experiments were performed to evaluate the effects of HH on CdSe nanocrystal size distribution.

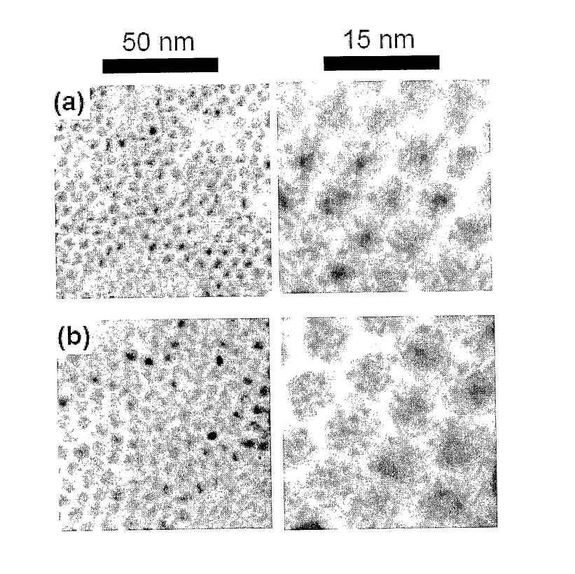

An important consideration in CdSe nanocrystal synthesis is the ability to vary nanocrystal size reproducibly over a range that allows broad spectral tuning. With slight modifications, the procedure described herein has been used to synthesize CdSe nanocrystals with optical bandgaps ranging from about 1.8 to 2.5 eV. This range of optical bandgaps corresponds roughly to a particle diameter range of 25-60 Å. FIG. 2 shows UV-visible absorption spectra and photoluminescence spectra of several samples of CdSe NCs with different particle sizes using HH as a coordinating ligand. This set of data demonstrates the wide tunability of particle size that is possible using HH as a capping ligand. The narrow emission peaks in these samples attest to the nearly monodisperse size distribution within the individual samples. Statistical analyses of size distributions in these samples were performed using the emission peak width method described above. In addition, particle sizes were also directly measured from transmission electron micrographs (100 particles per sample) for some of the samples. Representative TEM images of two of these samples are shown in FIG. 3. A complete listing of particle size statistics for the samples whose spectra are shown in FIG. 2 is given in Table 2.

TABLE 2
Size tunabilityh of CdSe NCs prepared in the presence of hexadecyl hexanoate (HH)

| | Peak Absorption | Peak Emission | Prevalent | | | |
|---|---|---|---|---|---|---|
| | Wavelength | Wavelength | Diameter | Emission | σ_{D} (%) | σ_{D} (%) |
| Sample | λₐ (nm) | λₑ (nm) | D (Å) | FWHM (nm) | (PL spectrum)^{a} | (TEM)^{b} |
| a | 625 | 632 | 59 | 23 | 11 | n/a |
| b | 587 | 591 | 41 | 21 | 10 | 5.9 |
| c | 580 | 586 | 38 | 22 | 9.8 | 5.6 |
| d | 566 | 571 | 34 | 21 | 9.4 | 5.6 |
| e | 555 | 563 | 32 | 20 | 9.3 | n/a |
| f | 522 | 529 | 26 | 21 | 8.0 | n/a |

^{a}Relative standard deviation as estimated by a Gaussian fit to the emission spectrum. This method exaggerates the absolute σ_{D} value, but is useful for comparison of samples.
^{b}Relative standard deviation as estimated from measurements on transmission electron micrographs (N = 100 particles).

The method described herein allows at least four different means to control particle size. First, changes in growth time allow for minor adjustments of particle size with longer times favoring larger particles. Second, the addition of excess non-coordinating solvent favors formation of smaller particles. The reason for this is that a larger number of nuclei are formed during the nucleation phase when the stearate capping ligands are diluted. Third, the nucleation temperature strongly influences particle size. Higher injection temperatures tend to yield larger particles. By controlling injection temperature over the range 200° C.-350° C., particle sizes can be varied from approximately 2 nm to 6 nm. Finally, the Cd:Se molar ratio also affects the size of the resulting particles. Under conditions typically employed in our laboratory, NCs less than about 4 nm in diameter can be obtained using a Cd:Se molar ratio of 1:10, while NCs of about 5 nm can be obtained with a Cd:Se ratio of about 1:5, and NCs of about 6 nm can be obtained with a Cd:Se ratio of 1:2. Further adjustments of the ratio lead to the production of still larger particles.

The Examples set forth herein are illustrative in nature and are not meant to limit the scope of the invention.

1. A method for producing monodisperse nanocrystals comprising the steps of:
a) preparing a precursor comprising a metal ion and a coordinating ligand;
b) dissolving the precursor in a solvent comprising one or more coordinating solvents;
c) raising the temperature of the of the mixture of step b into the range from 150° C. to 350° C.;
d) adding a chalcogen to the heated mixture of step c whereby the chalcogen reacts with the precursor; and
e) lowering the temperature of the mixture of step d to stop the reaction; and
f) maintaining the cooled mixture of step e for a sufficient time at a sufficient temperature to narrow the size distribution of the nanocrystals.

2. The method of claim 1 wherein the solvent further comprises a non-coordinating solvent.

3. The method of claim 2 wherein non-coordinating solvent is selected from the group consisting of selected from straight-chain, branched, and cyclic alkanes and alkenes.

4. The method of claim 2 wherein the non-coordinating solvent is liquid at room temperature and has a boiling point of 150° or higher.

5. The method of claim 2 wherein the non-coordinating solvent is selected from octadecene, octadecane, and combinations thereof.

6. The method of claim 1 wherein the metal ion is selected from the group consisting of Cd, Zn, Cu²⁺, Pb²⁺, Hg, and combinations thereof.

7. The method of claim 6 wherein the metal ion is Cd.

8. The method of claim 1 wherein the coordinating ligand is selected from the group consisting of carboxylic acids; amines; sulfonates; sulfoxides; phosphonates; di-carboxylic acids; diamines; ketones, aldehydes, esters and combinations thereof.

9. The method of claims 8 wherein the coordinating ligand is a carboxylic acid.

10. The method of claim 9 wherein the coordinating ligand is stearic acid.

11. The method of claim 1 wherein the coordinating solvent is selected from the group consisting of amines, carboxylic acids, sulfonates, sulfoxides, phosphonates, di-carboxylic acids, diamines, ketones, aldehydes, esters, and combinations thereof.

12. The method of claim 1 wherein the coordinating solvent is a mixture of TOPO and another coordinating solvent selected from the group consisting of amines, carboxylic acids, sulfonates, sulfoxides, phosphonates, di-carboxylic acids, diamines, ketones, aldehydes, esters, and combinations thereof.

13. The method of claim 1 wherein the chalcogen is selected from the group consisting of Se, S, Te, and combinations thereof.

14. The method of claim 13 wherein the chalcogen is Se.

15. The method of claim 1 wherein the polydispersity of the nanocrystals is +/−10% diameter.

16. The method of claim 15 wherein the polydispersity of the nanocrystals is from ±7% to ±10% diameter.

17. The method of claim 16 wherein the size distribution of the nanocrystals is ±5% diameter.

18. A method for producing monodisperse CdSe nanocrystals comprising the steps of:
a) preparing a precursor comprising Cd and a coordinating ligand;
b) dissolving the precursor in a solvent comprising one or more coordinating solvents and optionally one or more non-coordinating solvents;
c) raising the temperature of the of the mixture of step b into the range from 150° C. to 350° C.;
d) adding a Se to the heated mixture of step c whereby the Se reacts with the precursor to form CdSe nanocrystals;
e) lowering the temperature of the mixture of step d to stop the reaction; and
f) maintaining the cooled mixture of step e at the lowered temperature of step e for a time sufficient to narrow the size distribution of the nanocrystals.

19. The method of claims 18 wherein the coordinating ligand is selected from the group consisting of carboxylic acids; amines; sulfonates; sulfoxides; phosphonates; di-carboxylic acids; diamines; ketones, aldehydes, esters; and combinations thereof.

20. The method of claims 19 wherein the coordinating ligand is a carboxylic acid.

21. The method of claim 20 wherein the coordinating ligand is stearic acid.

22. The method of claim 18 wherein the coordinating solvent is selected from the group consisting of amines, carboxylic acids, sulfonates, sulfoxides, phosphonates, di-carboxylic acids, diamines, ketones, aldehydes, esters, and combinations thereof.

23. The method of claims 18 wherein the coordinating solvent is a mixture of TOPO and another coordinating solvent selected from the group consisting of amines, carboxylic acids, sulfonates, sulfoxides, phosphonates, di-carboxylic acids, diamines, ketones, aldehydes, esters, and combinations thereof.

24. The method of claims 18 wherein non-coordinating solvent is selected from the group consisting of selected from straight-chain, branched, and cyclic alkanes and alkenes.

25. The method of claim 24 wherein the non-coordinating solvent is liquid at room temperature and has a boiling point of 150° or higher.

26. The method of claim 25 wherein the non-coordinating solvent is selected from octadecene, octadecane, and combinations thereof.

27. The method of claim 18 wherein the cooled mixture of step e is maintained at 150° C. for 3 hours.
